(19) United States
(12) Patent Application Publication
(10) Pub. No.: US 2014/0222840 A1
(43) Pub. Date: Aug. 7, 2014

(54) INSERTION OF NON-REALTIME CONTENT TO COMPLETE INTERACTION RECORD

(71) Applicants: Abu Shaher Sanaullah, Austin, TX (US); James Webster Clardy, Austin, TX (US); Claude Lano Cox, Austin, TX (US); Richard William Schuckle, Austin, TX (US); Rocco Ancona, Austin, TX (US); Roy W. Stedman, Austin, TX (US); Charles Brooker, Cedar Park, TX (US)

(72) Inventors: Abu Shaher Sanaullah, Austin, TX (US); James Webster Clardy, Austin, TX (US); Claude Lano Cox, Austin, TX (US); Richard William Schuckle, Austin, TX (US); Rocco Ancona, Austin, TX (US); Roy W. Stedman, Austin, TX (US); Charles Brooker, Cedar Park, TX (US)

(21) Appl. No.: 13/757,326

(22) Filed: Feb. 1, 2013

(51) Int. Cl. G06F 17/30

(52) U.S. Cl. CPC G06F 17/30289
USPC 707/755

(57) ABSTRACT

A system and method for assembling a full interaction record for a meeting with non-realtime interaction is disclosed. The system and method may include recording a first plurality of data associated with the meeting to produce a meeting record at a first time, and determining whether to insert a placeholder in the meeting record at a point in the meeting record.

### TECHNICAL FIELD

This invention relates generally to the field of data recording and more specifically to insertion of non-realtime content to complete and interaction record.

### BACKGROUND

As the value and use of information continues to increase, individuals and businesses seek additional ways to process and store information. One option available to users is information handling systems (“IHSs”). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As the value and use of IHSs proliferate, so to do their use in facilitating collaboration between people and communities separate by time and distance. However, traditional barriers remain for realtime collaboration. One or more individuals may not be able to participate in a given meeting due to differences in time zones, schedules, or other obstacles. A record of the meeting, while helpful to those who may be unable to be present, may not provide the appropriate context for meeting discussions, may leave out important pieces of the discussion, or may be too unwieldy for the user to efficiently glean appropriate information. The ability to efficiently gain understanding from the meeting record and its context remains hindered by obstacles to realtime interaction.

### SUMMARY OF THE DISCLOSURE

In accordance with certain embodiments of the present disclosure, a system for assembling a full interaction record for a meeting with non-realtime interaction is disclosed. The system may include a processor, a recording unit communicatively coupled to the processor, wherein the recording unit configured to record a first plurality of data associated with the meeting to produce a meeting record at a first time, and a parsing engine communicatively coupled to the processor, the parsing engine configured to determine whether to insert a placeholder in the meeting record at a point in the meeting record. The placeholder may be configured to allow access to the meeting record by a user at a second time, the second time being later than the first time; allow access to the meeting record by the user at the point; and allow the user to record a second plurality of data associated with the meeting to the meeting record at the point.

In accordance with certain embodiments of the present disclosure, a system for assembling a full interaction record for a meeting with non-realtime interaction is disclosed. The system may include an interactive host, the interactive host comprising a processor; a recording unit communicatively coupled to the processor, the recording unit configured to record a first plurality of data associated with the meeting to produce a meeting record at a first time; a parsing engine communicatively coupled to the processor, the parsing engine configured to determine whether to insert a placeholder in the meeting record at a point in the meeting record; and an interaction portal. The interaction portal may be include a processor; a memory communicatively coupled to the processor, the memory having stored thereon the meeting record; and a meeting review module configured to allow access to the meeting record by a user at a second time, the second time being later than the first time; allow access to the meeting record by the user at the point; and allow the user to record a second plurality of data associated with the meeting to the meeting record at the point.

In accordance with certain embodiments of the present disclosure, a method for assembling a full interaction record for a meeting with non-realtime interaction is disclosed. The method may include initiating a meeting; recording a first plurality of data associated with the meeting to produce a meeting record at a first time; and determining whether to insert a placeholder in the meeting record at a point in the meeting record. The placeholder may be configured to allow access to the meeting record by a user at a second time, the second time being later than the first time; allow access to the meeting record by the user at the point; and allow the user to record a second plurality of data associated with the meeting to the meeting record at the point.

### BRIEF DESCRIPTION OF THE DRAWINGS

For a more complete understanding of the present invention and its advantages, reference is now made to the following description, taken in conjunction with the accompanying drawings, in which:

FIG. 1 illustrates an example information handling system for creating a full interaction record based on non-realtime interaction, in accordance with certain embodiments of the present disclosure;

FIG. 2 illustrates an example temporally-parsed record of a meeting hosted by interactive host, in accordance with certain embodiments of the present disclosure;

FIG. 3 illustrates an example topically-parsed record of a meeting hosted by interactive host, in accordance with certain embodiments of the present disclosure; and

FIG. 4 illustrates a flowchart of an example method for providing asynchronous interaction to create a full interaction record, in accordance with certain embodiments of the present disclosure.

### DETAILED DESCRIPTION OF THE INVENTION

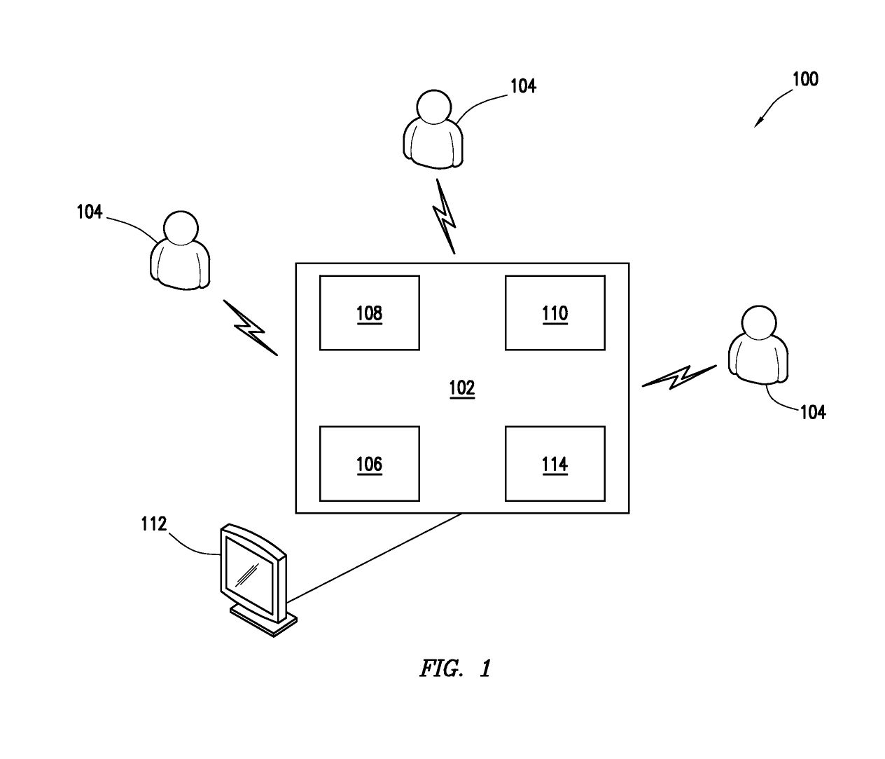

Preferred embodiments and their advantages are best understood by reference to FIGS. 1 through 4, wherein like numbers are used to indicate like and corresponding parts.

For the purposes of this disclosure, an information handling system (“IHS”) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The IHS may include memory, one or more processing resources, such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The IHS may also include one or more buses operable to transmit communication between the various hardware components.

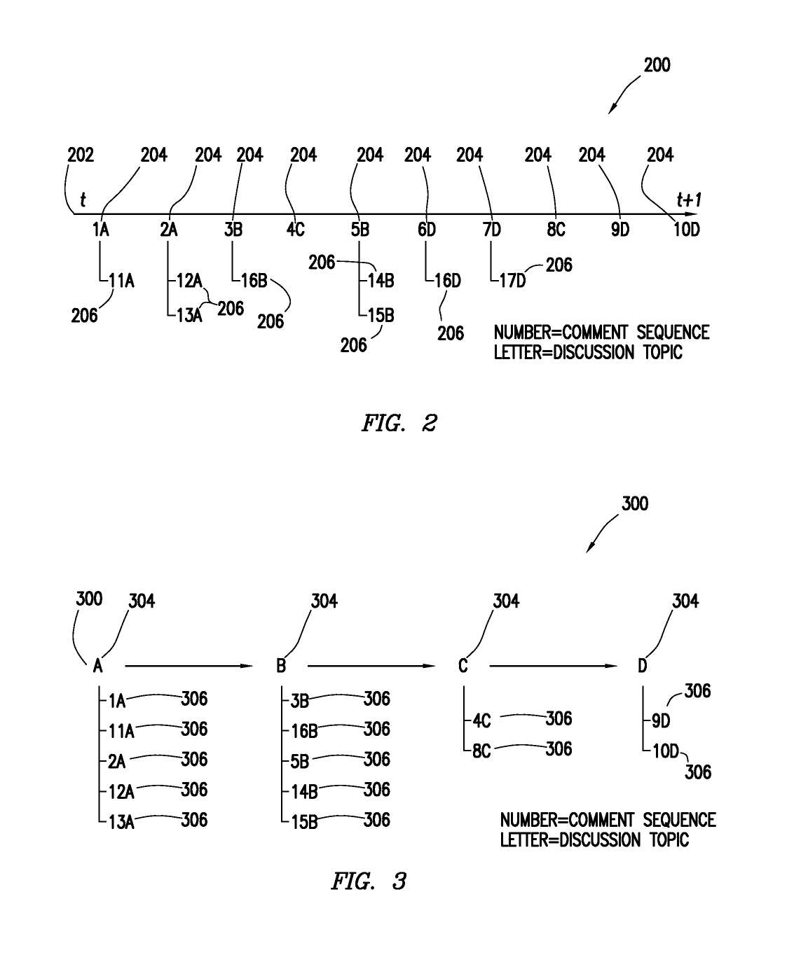

FIG. 1 illustrates an example information handling system (“IHS”) 100 for creating a full interaction record based on non-realtime interaction, in accordance with certain embodiments of the present disclosure. In some embodiments, IHS 100 includes interactive host 102 and one or more user(s) 104. Interactive host 102 may, in some embodiments, be configured to host one or more meetings, as described in more detail below with reference to FIGS. 2-4. User(s) 104 may be any IHS communicatively coupled to interactive host 102 and/or an individual interacting with interactive host 102. For example, user 104 may be a desktop computer, laptop computer, router, tablet computer, smart telephone, or other electronic device communicatively coupled to interactive host 102. As a further example, user 104 may be one or more individuals interacting directly with interactive host 102.

In some embodiments, interactive host 102 may include meeting host module 106, parsing engine 108, recording unit 110, display module 112, and interaction portal 114, communicatively coupled to one another. Interactive host 102 may be configured to host one or more meetings accessible to one or more user(s) 104 at different times. For the purposes of the present disclosure, a “meeting” may be broadly understood to be any gathering of user(s) 104 for distributing information between or among user(s) 104. For example, interactive host 102 may be a laptop computer configured to host a slideshow presentation (e.g., PowerPoint) as part of a business meeting. As another example, interactive host 102 may be one or more IHSs configured to facilitate a network-based discussion and/or presentation (e.g., WebEx). In a further example, interactive host 102 may be an HIS configured to automatically record and/or transcribe a live meeting between one or more user(s) 104. In some configurations, interactive host 102 may be some combination of these, as well as other examples of IHSs configured to host one or more meetings, as described in more detail below with reference to FIGS. 2-4.

For ease of illustration, interactive host 102 is illustrated as a single, colocated IHS. In some configurations of interactive host 102 (e.g., recording and/or transcribing of a live conversation), all components of interactive host 102 may be past of a single, colocated IHS. In other configurations, however, interactive host 102 may comprise multiple IHSs, including configurations in which multiple IHSs are located remotely from one another. For example, in the example described above of a network-based discussion and/or presentation, interactive host 102 may include portions of the IHS on which an individual user 104 connects to the network-based discussion and/or presentation, as well as (or in the alternative) a central IHS to which each user 104 may connect. One of ordinary skill in the art would recognize that many different configurations of interactive host 102 are possible without departing from the scope of the present disclosure.

In some embodiments, meeting host module 106 may be a component of interactive host 102 configured to process data associated with the meeting hosted by interactive host 102, including any necessary management functions. For instance, corresponding to the examples above, meeting host module 106 may be a portion of one or more IHSs configured to execute instructions associated with a slideshow presentation, a network-based discussion, transcribing a live conversation, and/or some combination thereof.

In the same or alternative some embodiments, meeting host module 106 may be configured to perform certain management tasks for interactive host 102. For example, meeting host module 106 may be configured to provide communication management between or among parsing engine 108, recording unit 110, display 112, and/or interaction portal 114. As an additional example, meeting host module 106 may be configured to provide management of the underlying resources of some or all of interactive host 102 (e.g., processor and/or memory resources).

Meeting host module 106 may be, in some embodiments, a software program stored on computer-readable media and executable by a processor of interactive host 102. For clarity of description FIG. 1 depicts meeting host module 106 as a separate module. In some embodiments, meeting host module 106 may be a stand-alone software program. However, meeting host module 106 may also be a component or subroutine of a larger software program, such as the operating system, or hard-coded into computer-readable media, firmware stored on computer-readable media, and/or any hardware or software module configured to process data associated with the meeting hosted by interactive host 102, including any necessary management functions.

In some embodiments, the recording of data relevant to a meeting may be recorded by recording unit 110. In some configurations, recording unit 110 may be configured to record audio and/or visual signals associated with a live meeting. For example, a microphone, video camera, or other data gathering device may be used to capture a meeting. In the same or alternative configurations, recording unit 110 may be configured to record data associated with an electronic meeting. For example, a memory may be configured to record keystrokes, drawings, annotations, and/or other electronic means of capturing meeting information. In further configurations, recording unit 110 may be configured to be some combination of these and/or other recording mechanisms. For instance, in the example of the network-based meeting, recording device 110 may be configured to record the conversation between or among one or user(s) 104, a slideshow presentation associated with the meeting, annotations made to the slides during the course of the meeting, text or other electronic comments supplied by user(s) 104 during the course of the meeting, and/or any relevant data and/or metadata associated with the recorded data as described in more detail below with reference to parsing engine 108 and FIGS. 2-4.

Recording unit 110 may be, in some embodiments, a software program stored on computer-readable media and executable by a processor of interactive host 102. For clarity of description FIG. 1 depicts recording unit 110 as a separate module. In some embodiments, recording unit 110 may be a stand-alone software program. However, recording unit 110 may also be a component or subroutine of a larger software program, such as the operating system, or hard-coded into computer-readable media, firmware stored on computer-readable media, and/or any hardware or software module configured to record data relevant to the instant meeting. Further, recording unit 110 may include external recording devices such as a microphone and/or video camera.

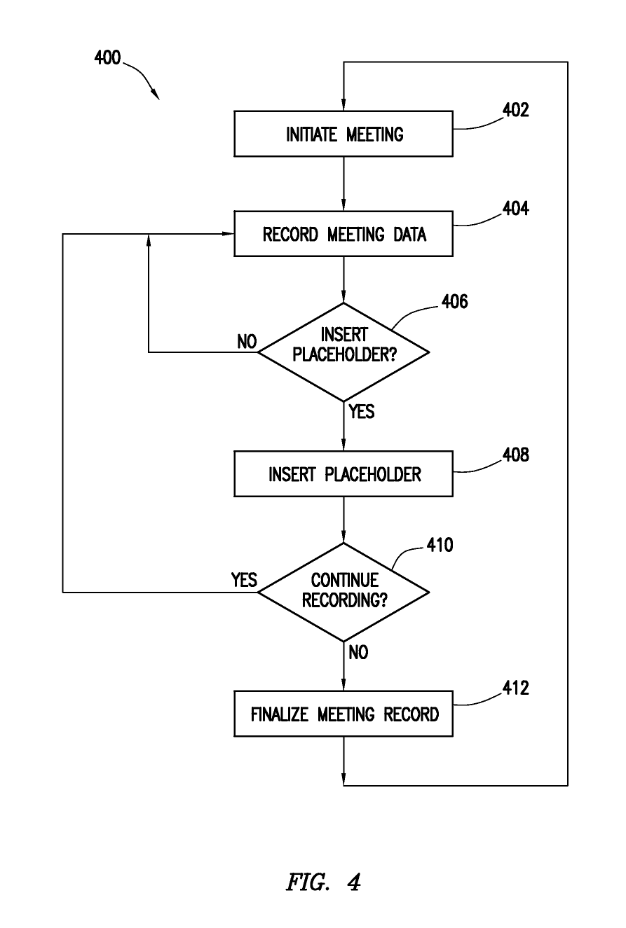

In order to render the recorded data usable for asynchronous interaction, interactive host 102 may also include parsing engine 108. In some embodiments, parsing engine 108 may be configured to parse the data recorded by recording unit 110 into placeholders identified by one or more user(s) 104. In some configurations of interactive host 102, user(s) 104 may seek to parse the recorded data based on topical placeholders, as described in more detail below with reference to FIGS. 2 and 4. In such configurations, parsing engine 108 may be configured to identify instances at which a subsequent user 104 wishes to interact with the record of the meeting. For example, user 104, reviewing the record of a meeting at a later time, may wish to insert commentary at a certain temporal location of the meeting record. Parsing engine 108 may be configured to identify this location and mark the data such that later, asynchronous commentary may be added at the same location.

In the same or alternative configurations of interactive host 102, user(s) 104 may seek to parse the recorded data based on topical placeholders, as described in more detail below with reference to FIGS. 3-4. In such configurations, parsing engine 108 may be configured to identify topics within the record of a meeting. In this way, subsequent reviewers of the meeting record may add commentary to the meeting record and have this commentary topically organized. As described in more detail below with reference to FIG. 3, such topical placeholders may be generated through a variety of means, depending on the desired configuration interactive host 102.

Parsing engine 108 may be, in some embodiments, a software program stored on computer-readable media and executable by a processor of interactive host 102. For clarity of description FIG. 1 depicts parsing engine 108 as a separate module. In some embodiments, parsing engine 108 may be a stand-alone software program. However, parsing engine 108 may also be a component or subroutine of a larger software program, such as the operating system, or hard-coded into computer-readable media, firmware stored on computer-readable media, and/or any hardware or software module configured to parse the data recorded by recording unit 110 into placeholders identified by one or more user(s) 104.

In some embodiments, interactive host 102 may also include display 112 configured to enable the display a record of the meeting to one or more user(s) 104. In some configurations, display 112 may be configured to display a record of the meeting in realtime to the user(s) 104 participating in the meeting in realtime. In such configurations, display 112 may be configured to display the record of the meeting in an ongoing manner. In the same or alternative configurations, display 112 may be configured to display a record of the meeting after the initial, realtime meeting has completed. For example, a user 104 wishing to add commentary to the meeting record in an asynchronous manner may view some or all of the meeting record to the asynchronous user(s) 104.

In some embodiments, display 112 may be a physical display element, such as a computer monitor, laptop screen, smart telephone screen, tablet screen, etc. In the same or alternative embodiments, display 112 may be a software program stored on computer-readable media and executable by a processor of interactive host 102. For example, display 112 may be a device driver, webpage, web server, or any other electronic device and/or document configured to enable the display of the meeting record. For clarity of description FIG. 1 depicts display 112 as a separate module. In some embodiments, depicts display 112 may be a stand-alone software program. However, depicts display 112 may also be a component or subroutine of a larger software program, such as the operating system, or hard-coded into computer-readable media, firmware stored on computer-readable media, and/or any hardware or software module configured to enable the display a record of the meeting to one or more user(s) 104.

In some embodiments, interactive host 102 may also include interaction portal 114 configured to allow one or more user(s) 104 to interact with the meeting record. For example, interaction portal 114 may be a data entry device (e.g., a keyboard, mouse, microphone, etc.). In the same or alternative configurations, interaction portal 114 may be a software program stored on computer-readable media and executable by a processor of interactive host 102. For example, interactive host 102 may be a network interface module and/or driver, and/or any other electronic device and/or module configured to allow one or more user(s) 104 to interact with the meeting record. For clarity of description FIG. 1 depicts interaction portal 114 as a separate module. In some embodiments, depicts interaction portal 114 may be a stand-alone software program. However, depicts interaction portal 114 may also be a component or subroutine of a larger software program, such as the operating system, or hard-coded into computer-readable media, firmware stored on computer-readable media, and/or any hardware or software module configured to allow one or more user(s) 104 to interact with the meeting record.

In operation, one or more user(s) 104 may gather locally and/or remotely in order to conduct a meeting using interactive host 102. Due to the nature of modern workplaces and the often disparate locations of individuals who may wish to collaborate, it may be difficult or impossible for all user(s) 104 too attend a meeting at the same time and/or location. For those user(s) 104 who are able to interact at a given time, recording unit 110 may record data associated with the meeting hosted via meeting host module 106. During the course of the meeting, recording unit 110 may further record data associated with the meeting, such as comments, annotations, drawings, etc. Further, as data is recorded and/or as a subsequent process, parsing engine 110 may parse the data recorded by recording unit 110 into placeholders identified by one or more user(s) 104. In some configurations, this may done automatically. In the same or alternative configurations, user(s) 104 may insert placeholders manually. Once the meeting has been recorded and parsed, user(s) 104 that were unable to attend the meeting may then be able to access the meeting record via meeting host module 106 and interaction portal 114.

In some embodiments, recording unit 110 may record further comments and/or other data supplied by subsequent user(s) 104 as described in more detail below with reference to FIGS. 2-4. This subsequent commentary and/or other data may then be placed alongside the original meeting data in accordance with the placeholders established via parsing engine 108. Other iterations of this process may then commence, with user(s) 104 able to access the augmented meeting record via meeting host module 106 and interaction portal 114. By accessing the meeting record, and subsequent, asynchronous interactions aligned with placeholder implemented by parsing engine 108, user(s) 104 may interact more effectively with fewer temporal limitations.

FIG. 2 illustrates an example temporally-parsed record 200 of a meeting hosted by interactive host 102, in accordance with certain embodiments of the present disclosure. In some embodiments, record 200 includes timeline 202, topical placeholders 204, and asynchronous commentary markers 206. In some embodiments, topical placeholders 204 and/or asynchronous commentary markers 206 may be placed in the meeting record as data and/or metadata associated with the meeting data.

Record 200 is provided as illustration to aid in understanding. One of ordinary skill in the art would recognize that actual configurations of interactive host 102, as described in more detail above with reference to FIG. 1 and below with reference to FIGS. 3-4, may product different records without departing from the scope of the present disclosure.

In the example record 200, timeline 202 extends from time t to time t+i. This may represent the actual time over which a meeting originally took place. For example, timeline 202 may extend over the course of one hour. Denoted on timeline 202 are a plurality of topical placeholders 204. In some embodiments, topical placeholders 204 may be included by parsing engine 108 of interactive host 102, as described in more detail above with reference to FIG. 1. For example, one or more user(s) 104 of interactive host 102 may have provided additional commentary during the course of the meeting. For instance, in the example of a slideshow presentation, topical placeholders 204 may represent the moments in time at which one or more user(s) 104 had a question about the content of a slide and a more in-depth discussion occurred.

In the example record 200 of FIG. 2, topical placeholders 204 are denoted as 1A, 2A, 3B, 4C, 5B, 6D, 7D, 8C, 9D, and 10D. As described in more detail below with reference to FIGS. 3-4, these labels refer to an example set of commentary, wherein the number (e.g., 1, 2, 3, etc.) indicates the temporal sequence of the comments and the letter (e.g., A, B, C, D, etc.) indicates a topical associated with the comment. Referring again generally to FIG. 2, topical placeholders 204 may, in some embodiments, have associated with them a time and/or a topic. One comment may, in some embodiments, have more than one topic associated with it. In example record 200, the comments may be arranged temporally to give user(s) 104 one context for understanding the importance and/or meaning of a particular comment.

Example record 200 may also include one or more asynchronous commentary markers 206. When one or more user(s) 104 wish to interact with the meeting record at a time later than the original meeting, user(s) 104 may access the meeting record via meeting host module 106 and interaction portal 114. User(s) 104 may then be able to view comments made at certain times by examining topical placeholders 204. User(s) 104 may then wish to add to the discussion regarding a particular earlier point. In some embodiments, asynchronous commentary markers 206 may be included by parsing engine 108 and/or recording unit 110 of interactive host 102, as described in more detail above with reference to FIG. 1. For example, one or more later user(s) 104 of interactive host 102 may with to provide additional commentary after the meeting.

In the example record 200 of FIG. 2, asynchronous commentary markers 206 are denoted as 11A, 12A, 13A, 14B, 15B, 16B, 16D, 17D. As described in more detail below with reference to FIGS. 3-4, these labels refer to an example set of commentary, wherein the number (e.g., 1, 2, 3, etc.) indicates the temporal sequence of the comments and the letter (e.g., A, B, C, D, etc.) indicates a topical associated with the comment. Referring again generally to FIG. 2, topical placeholders 204 may, in some embodiments, have associated with them a time and/or a topic. One comment may, in some embodiments, have more than one topic associated with it. In example record 200, the comments may be arranged temporally to give user(s) 104 a context for understanding the importance and/or meaning of a particular comment. For example, user(s) 104 may be able to see that there were two sets of comments, 14B and 15B, left at two different times following the meeting, that relate to the topic discussed at time 5 and dealing with topic B.

In some embodiments, topics may be tagged through a variety of means configured to indicate a move from one topic to another. For example, keywords and/or phrases may be inserted into a meeting discussion in order to flag a potential location for topical placeholder 204 to parsing engine 108 of interactive host 102. These keywords and/or phrases may include, for example, “moving on to [next topic],” which may indicate that subsequent comments should be associated with the next topic; “going back to [previous topic],” which may indicate that subsequent comments should be associated with a previous topic; and/or “action item for [person],” which may indicate that a particular user(s) 104 has been assigned a task. As another example, changes made to an electronic document as part of the meeting may trigger topical placeholder 204. For example, when using a slideshow presentation, topical placeholders 204 may be associated with individual slides to indicate that commentary should be associated with that slide. Further, these an other means of providing topical placeholders 204 may be combined and/or supplemented to provide a desired level of granularity.

In some embodiments, the triggering of topical placeholder 204 may be configurable by a user of information handling system 100. For example, a user may select the type of event that may trigger topical placeholder 204, including whether the event is software-based, voice-activated, and/or other events that may trigger topical placeholder 204. In some configurations, a user of information handling system 100 may wish some combination of events to be used for a particular meeting record.

Further, in some embodiments, a visual, audio, and/or other indicator of the trigger of topical placeholder 204 may be generated as a result of triggering topical placeholder 204. For example, in an online meeting, a visual indicator may appear on screen to inform users of the triggering of topical placeholder 204. In some embodiments, this may allow for the meeting record to be reviewed and/or edited in real-time and/or near real-time, as described in more detail above with reference to FIG. 1 and below with reference to FIGS. 3-4.

FIG. 3 illustrates an example topically-parsed record 300 of a meeting hosted by interactive host 103, in accordance with certain embodiments of the present disclosure. In some embodiments, record 300 includes timeline 302, topical placeholders 304, and asynchronous commentary markers 306. In some embodiments, topical placeholders 304 and/or asynchronous commentary markers 306 may be placed in the meeting record as data and/or metadata associated with the meeting data.

Record 300 is provided as illustration to aid in understanding. One of ordinary skill in the art would recognize that actual configurations of interactive host 103, as described in more detail above with reference to FIGS. 1-2 and below with reference to FIG. 4, may product different records without departing from the scope of the present disclosure.

In the example record 300, timeline 302 includes a list of topics discussed during the meeting, arranged chronologically. Timeline 302 may represent some set of the topics discussed during the meeting. Denoted on timeline 302 are a plurality of topical placeholders 304. In some embodiments, topical placeholders 304 may be included by parsing engine 108 of interactive host 103, as described in more detail above with reference to FIG. 1.

In some embodiments, topics may be tagged through a variety of means configured to indicate a move from one topic to another. For example, keywords and/or phrases may be inserted into a meeting discussion in order to flag a potential location for topical placeholder 304 to parsing engine 108 of interactive host 102. These keywords and/or phrases may include, for example, “moving on to [next topic],” which may indicate that subsequent comments should be associated with the next topic; “going back to [previous topic],” which may indicate that subsequent comments should be associated with a previous topic; and/or “action item for [person],” which may indicate that a particular user(s) 104 has been assigned a task. As another example, changes made to an electronic document as part of the meeting may trigger topical placeholder 304. For example, when using a slideshow presentation, topical placeholders 304 may be associated with individual slides to indicate that commentary should be associated with that slide. Further, these an other means of providing topical placeholders 204 may be combined and/or supplemented to provide a desired level of granularity.

In some embodiments, the triggering of topical placeholder 304 may be configurable by a user of information handling system 100. For example, a user may select the type of event that may trigger topical placeholder 304, including whether the event is software-based, voice-activated, and/or other events that may trigger topical placeholder 304. In some configurations, a user of information handling system 100 may wish some combination of events to be used for a particular meeting record.

Further, in some embodiments, a visual, audio, and/or other indicator of the trigger of topical placeholder 304 may be generated as a result of triggering topical placeholder 304. For example, in an online meeting, a visual indicator may appear on screen to inform users of the triggering of topical placeholder 304. In some embodiments, this may allow for the meeting record to be reviewed and/or edited in real-time and/or near real-time, as described in more detail above with reference to FIGS. 1-2 and below with reference to FIG. 4.

Example record 300 may also include one or more asynchronous commentary markers 306. When one or more user(s) 104 wish to interact with the meeting record at a time later than the original meeting, user(s) 104 may access the meeting record via meeting host module 106 and interaction portal 114. User(s) 104 may then be able to view comments made with respect to certain topics by examining topical placeholders 304. User(s) 104 may then wish to add to the discussion regarding a particular topic. In some embodiments, asynchronous commentary markers 306 may be included by parsing engine 108 and/or recording unit 110 of interactive host 103, as described in more detail above with reference to FIG. 1. For example, one or more later user(s) 104 of interactive host 103 may with to provide additional commentary after the meeting.

In the example record 300 of FIG. 3, asynchronous commentary markers 306 are denoted as 11A, 13A, 13A, 14B, 15B, 16B, 16D, 17D. As described in more detail above with reference to FIG. 2 and below with reference to FIG. 4, these labels refer to an example set of commentary, wherein the number (e.g., 1, 3, 3, etc.) indicates the temporal sequence of the comments and the letter (e.g., A, B, C, D, etc.) indicates a topical associated with the comment. Referring again generally to FIG. 3, topical placeholders 304 may, in some embodiments, have associated with them a time and/or a topic. One comment may, in some embodiments, have more than one topic associated with it. In example record 300, the comments may be arranged topically to give user(s) 104 a context for understanding the importance and/or meaning of a particular comment. For example, user(s) 104 may be able to see a complete set of comments relevant to a particular topic.

FIG. 4 illustrates a flowchart of an example method 400 for providing asynchronous interaction to create a full interaction record, in accordance with certain embodiments of the present disclosure. Method 400 includes initiating a meeting, recording the meeting data, inserting placeholders, and finalizing the meeting record.

According to one embodiment, method 400 preferably begins at step 402. Teachings of the present disclosure may be implemented in a variety of configurations. As such, the preferred initialization point for method 400 and the order of steps 402-411 comprising method 400 may depend on the implementation chosen.

In some embodiments, the steps of method 400 may be performed by some or all of the components of system 100, as described in more detail above with reference to FIGS. 1-3. For example, in some configurations, parsing engine 108 may be responsible for determining whether to insert placeholders. In other configurations, these steps may be performed by different components of system 100 with departing from the scope of the present disclosure.

At step 402, method 400 may initiate a meeting, as described in more detail above with reference to FIGS. 1-3. For example, one or more user(s) 104 may initialize meeting host module 106 in order to begin the meeting and subsequent recording steps. After initiating the meeting, method 400 may proceed to step 404.

At step 404, method 400 may begin recording the meeting data, as described in more detail above with reference to FIGS. 1-3. For example, recording unit 110 may begin recording data associated with voices, video, text, drawings, annotations, and/or other data associated with the meeting. After recording begins, method 400 may proceed to step 406.

At step 406, method 400 may determine whether to insert a placeholder in the meeting record, as described in more detail above with reference to FIGS. 1-3. For example, as described in more detail above with reference to FIGS. 2-3, parsing engine 108 of system 100 may determine from voice commands, changes in a slideshow presentation, and/or other data and/or metadata that a temporal and/or topical placeholder should be inserted into the meeting record. If no placeholder is to be inserted, method 400 may return to step 404. If a placeholder is to be inserted, method 400 may proceed to step 408.

At step 408, method 400 may insert a temporal and/or topical placeholder into the meeting record, as described in more detail above with reference to FIGS. 1-3. After inserting the placeholder, method 400 may proceed to step 410. At step 410, method 400 may determine whether recording should continue. If no more recording is required (e.g., if the meeting is over), method 400 may return to step 402 to await a new meeting. If more recording is required, method 400 may return to step 404.

Although FIG. 4 discloses a particular number of steps to be taken with respect to method 400, method 400 may be executed with more or fewer steps than those depicted in FIG. 4. In addition, although FIG. 4 discloses a certain order of steps comprising method 400, the steps comprising method 400 may be completed in any suitable order. For example, in the embodiment of method 400 shown, the determination to insert a placeholder is done prior to the determination to continue recording. However, in some configurations, the responsibility for carrying out these steps may be held by separate components of system 100, allowing continuous recording while the placeholder determination is made

What is claimed:

1. A system for assembling a full interaction record for a meeting with non-realtime interaction, the system comprising:
a processor;
a recording unit communicatively coupled to the processor, the recording unit configured to record a first plurality of data associated with the meeting to produce a meeting record at a first time; and
a parsing engine communicatively coupled to the processor, the parsing engine configured to determine whether to insert a placeholder in the meeting record at a point in the meeting record, wherein the placeholder is configured to:
allow access to the meeting record by a user at a second time, the second time being later than the first time;
allow access to the meeting record by the user at the point; and
allow the user to record a second plurality of data associated with the meeting to the meeting record at the point.

2. The system of claim 1, wherein the placeholder is a temporal placeholder.

3. The system of claim 1, wherein the placeholder is a topical placeholder.

4. The system of claim 1, wherein the meeting record is configured to be displayed to the user temporally.

5. The system of claim 1, wherein the meeting record is configured to be displayed to the user topically.

6. The system of claim 1, wherein the parsing engine is further configured to be responsive to a voice command in order to insert the placeholder.

7. The system of claim 1, wherein the parsing engine is further configured to be responsive to an electronic command in order to insert the placeholder.

8. A system for assembling a full interaction record for a meeting with non-realtime interaction, the system comprising:
an interactive host, the interactive host comprising:
a processor;
a recording unit communicatively coupled to the processor, the recording unit configured to record a first plurality of data associated with the meeting to produce a meeting record at a first time;
a parsing engine communicatively coupled to the processor, the parsing engine configured to determine whether to insert a placeholder in the meeting record at a point in the meeting record; and
an interaction portal, the interaction portal comprising:
a processor;
a memory communicatively coupled to the processor, the memory having stored thereon the meeting record;
a meeting review module configured to:
a low access to the meeting record by a user at a second time, the second time being later than the first time;
allow access to the meeting record by the user at the point; and
allow the user to record a second plurality of data associated with the meeting to the meeting record at the point.

9. The system of claim 8, wherein the placeholder is a temporal placeholder.

10. The system of claim 8, wherein the placeholder is a topical placeholder.

11. The system of claim 8, wherein the meeting review module is further configured to display the meeting record to the user temporally.

12. The system of claim 8, wherein the meeting review module is further configured to display the meeting record to the user topically.

13. The system of claim 8, wherein the parsing engine is further configured to be responsive to a voice command in order to insert the placeholder.

14. The system of claim 8, wherein the parsing engine is further configured to be responsive to an electronic command in order to insert the placeholder.

15. A method for assembling a full interaction record for a meeting with non-realtime interaction, the method comprising:
initiating a meeting;
recording a first plurality of data associated with the meeting to produce a meeting record at a first time; and
determining whether to insert a placeholder in the meeting record at a point in the meeting record, wherein the placeholder is configured to:
allow access to the meeting record by a user at a second time, the second time being later than the first time;
allow access to the meeting record by the user at the point; and
allow the user to record a second plurality of data associated with the meeting to the meeting record at the point.

16. The method of claim 15, wherein the placeholder is a temporal placeholder.

17. The method of claim 15, wherein the placeholder is a topical placeholder.

18. The method of claim 15, wherein the meeting record is configured to be displayed to the user temporally.

19. The method of claim 15, wherein the meeting record is configured to be displayed to the user topically.

20. The method of claim 15, wherein determining whether to insert the placeholder comprises inserting the placeholder if a voice command or an electronic command is received.
